(19) United States
(12) Patent Application Publication
(10) Pub. No.: US 2007/0175336 A1
(43) Pub. Date: Aug. 2, 2007

(54) Coffee maker

(76) Inventor: Chun-liang Yeh, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/344,242

(22) Filed: Feb. 1, 2006

(51) Int. Cl. A47J 31/00

(52) U.S. Cl. 99/279

(57) ABSTRACT

A coffee maker includes a boiler, a milk whipper, and a selector. The boiler supplies steam to the milk whipper. The milk whipper is inserted to a hollow cap connecting through the milk whipper. The milk whipper contains a suction tube to suck the milk at the bottom of a milk cup into the upper section in the cap to be fast beaten into cream. The selector includes a lid, an elastic member, and a base. The lid is connected through the boiler. The elastic member is fixed to the base. The lid is pivoted to the base and holds against the elastic member in its normal status. Hot water is supplied by turning a hot water supply line of the lid to align with a water outlet of the base. Steam is supplied by turning a steam supply line of the lid to align with a steam outlet of the base.

### BACKGROUND OF THE INVENTION

(a) Field of the Invention

The present invention relates to a coffee maker, and more particularly, to one with a milk whipper containing a suction tube to suck the milk at the bottom of a milk cup to the upper section of a cap to be beaten at acceleration into thick cream while a selector seals a lid with an elastic member to supply hot water or steam by turning the lid for minimizing the failure of the selector.

(b) Description of the Prior Art

Whereas the design of a conventional coffee maker, the selector of hot water and steam usually achieves the switch operation by interaction among ceramic valves. Precision is highly demanded in the processing of the ceramic valves, and the rejection rate is also comparatively higher in semi-products and finished products leading to higher total cost.

Hot water and steam available in the coffee maker with the former for making the coffee, and the steam for whipping the milk into thick cream. However, the milk whipper found in the prior art of the coffee maker relates to a tube with its terminal directly mounted with a cap. Accordingly, the tube only allows fast whipping of the milk in the upper portion of the milk cup; however, it is difficult for the milk in the lower portion, particularly that closer to the bottom of the milk cup to be whipped into thick cream.

### SUMMARY OF THE INVENTION

The primary purpose of the present invention is to provide a coffee maker that allows the milk in the lower portion of the milk cup to be fast sucked to the upper section in the cap for making cream and has a selector sealed to a lid for supplying hot water or steam by turning the lid thus to minimize the failure of the selector.

To achieve the purpose, the present invention includes a boiler, a milk whipper, and a selector. The coffee pot provides steam to the milk whipper connected with a hollow cap; the cap in turn connects through the milk whipper; the milk whipper includes a suction tube; and the suction tube is provided with a first end and a second end with the first end fixed to an inner side of the cap and connected through the upper portion of the cap and the second end connected through the lower portion of the cap. The selector includes a lid, an elastic member, and a base. The lid is disposed with a hot water supply line and a steam supply line to respectively connect through the boiler. The elastic member is fixed to the base and a hot water outlet and a steam outlet are respectively provided on the base. The lid is pivoted to the base and the lid in its normal condition holds against the elastic member. The elastic member in its normal condition seals both the hot water and steam supply lines of the lid. By turning the lid so that its hot water supply line is aligned with the hot water outlet of the base, the hot water is supplied; or turning the lid so that its steam supply line is aligned with the steam outlet of the base, the steam is supplied.

The elastic member is disposed with a hot water port in relation to the hot water outlet of the base, and a steam port in relation to the steam outlet of the base.

Alternatively, the present invention may include a boiler, a milk whipper, and a selector. The boiler supplies steam to the milk whipper through the selector. The milk whipper is connected to a hollow cap, and the cap connects through the milk whipper. The milk whipper contains a suction tube provided with a first end and a second end. The first end of the suction tube is fixed inside the cap and connected through the upper section inside the cap and the second end of the suction tube is connected through the lower section inside the cap.

The present invention may also include a boiler, a milk whipper, and a selector. The boiler supplies steam to the milk whipper through the selector. The selector comprises a lid, an elastic member, and a base. The lid is disposed with a hot water supply line and a steam supply line respectively connected through the boiler. A hot water port and a steam port are disposed in the elastic member, and a hot water outlet and a steam outlet are disposed in the base. The elastic member is fixed to the base. The lid is pivoted to the base and holds against the elastic member in its normal status. The elastic member in its normal status seals the hot water and steam supply lines of the lid. To supply hot water, the lid is turned to where its hot water supply line is aligned with the hot water outlet. To supply steam, the lid is turned to where its steam supply line is aligned with the steam outlet.

The hot water port of the elastic member is disposed at where in relation to the hot water outlet of the base; and the steam port of the elastic member is disposed at where in relation to the steam outlet of the base.

A micro-switch is provided on the base of the selector, and corresponding lugs are disposed on the lid. A heater is provided to the boiler and the micro-switch is connected to the heater of the boiler so to have the lugs to turn on or off the micro-switch by turning the lid.

The present invention provides the following advantages:

1. Minimized failure rate to the selector and prevented overflow because the lid is sealed by the elastic member;

2. Lower production cost since the elastic member may absorb certain process error, and relatively the demanded process precision of the components can be attained at the ordinary level; and

3. It allows faster whipping all the milk in the cup into thick cream.

### BRIEF DESCRIPTION OF THE DRAWINGS

FIG. 1 is a perspective view of a preferred embodiment of the present invention [with those non-characteristic portions omitted].

FIG. 2 is a cross-sectional view of a milk whipper of the preferred embodiment of the present invention.

FIG. 3 is a schematic view showing that the status of the preferred embodiment of the present invention is not in use [a top view but with certain components omitted].

FIG. 4 is a schematic view showing hot water is supplied by the preferred embodiment of the present invention.

FIG. 5 is a schematic view showing steam is supplied by the preferred embodiment of the present invention.

FIG. 6 is a schematic view showing milk whipping by the preferred embodiment of the present invention.

### DETAILED DESCRIPTION OF THE PREFERRED EMBODIMENTS

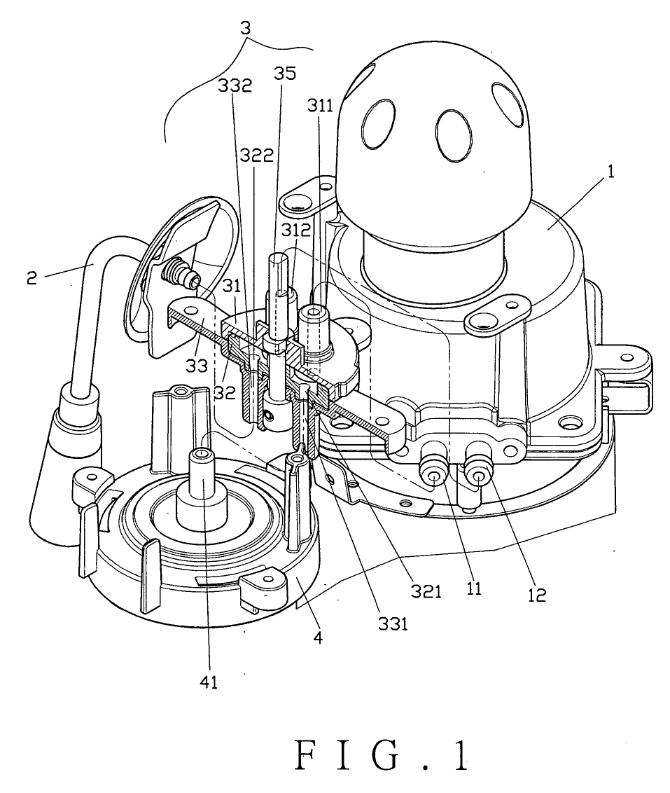

Referring to FIG. 1, a preferred embodiment of the present invention includes a boiler (1), a milk whipper (2), a selector (3), and a coffee pot (4).

The boiler (1) is provided with a hot water supply line (11) and a steam supply line (12).

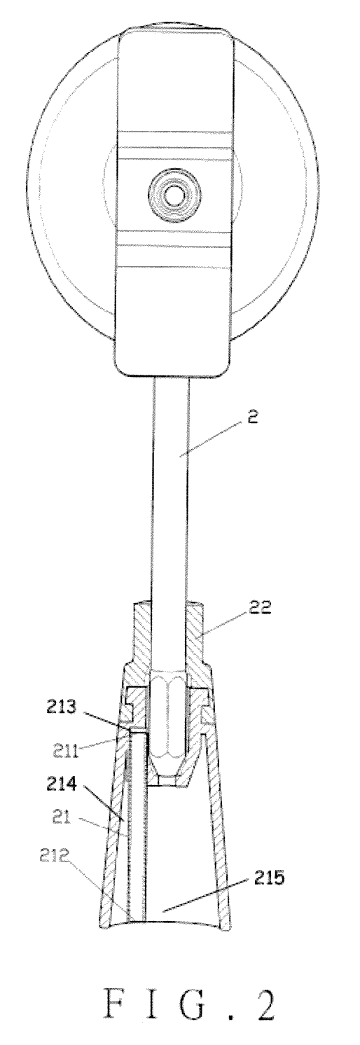

The milk whipper (2), as illustrated in FIG. 2, includes a suction tube (21) and a hollow cap (22). The suction tube (21) has a first end (211) and a second end (212) with the first end (211) of the suction tube (21) fixed to an inner side of the cap (22) and connected through the upper section in the cap (22) and the second end (212) of the suction tube (21) connected through the lower section in the cap (22).

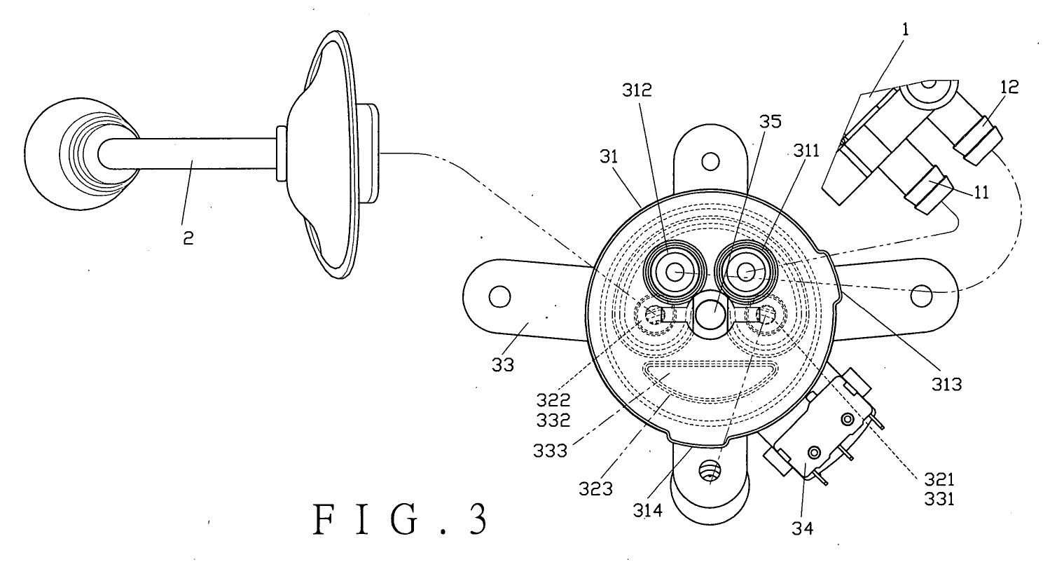

Now referring to FIGS. 1 and 3, the selector (3) includes a lid (31), an elastic member (32), a base (33), a micro-switch (34), and a spindle (35). The lid (31) is disposed with a hot water supply line (311) and a steam supply line (312) to respectively connect through the boiler (1). The elastic member (32) is disposed with a hot water port (321) and a steam port (322) and an indention (323). The base (33) is disposed with a hot water outlet (331), a steam outlet (332), and an insertion block (333). The elastic member (32) is fixed to the base (33) with the indention (323) corresponding to the insertion block (333). The hot water port (321) of the elastic member (32) is disposed in relation to the hot water outlet (331) of the base (33) and the steam port (322) of the elastic member (32) is disposed in relation to the steam outlet (332). The base (33) is pivoted to the lower section of the spindle (35) and the lid (31) is fixed to the spindle (35) and pivoted to the base (33). As illustrated in FIG. 3, the lid (31) in its normal status holds against the elastic member (32), and the elastic member (32) in its normal status seals the hot water supply line (311) and the steam supply line (312) of the lid (31). The base (33) of the selector (3) is provided with the micro-switch (34) connected to the boiler (1) (wherein a heater is generally provided to the boiler (1) to heat up the water stored in the boiler (1)). The lid (31) is provided with a pair of lugs (313, 314) corresponding to the micro-switch (34). Control of the on/off status of the micro-switch (34) is achieved by turning the lid (31) to correspond to the lugs (313, 314).

The coffee pot (4) is disposed with a hot water supply line (41).

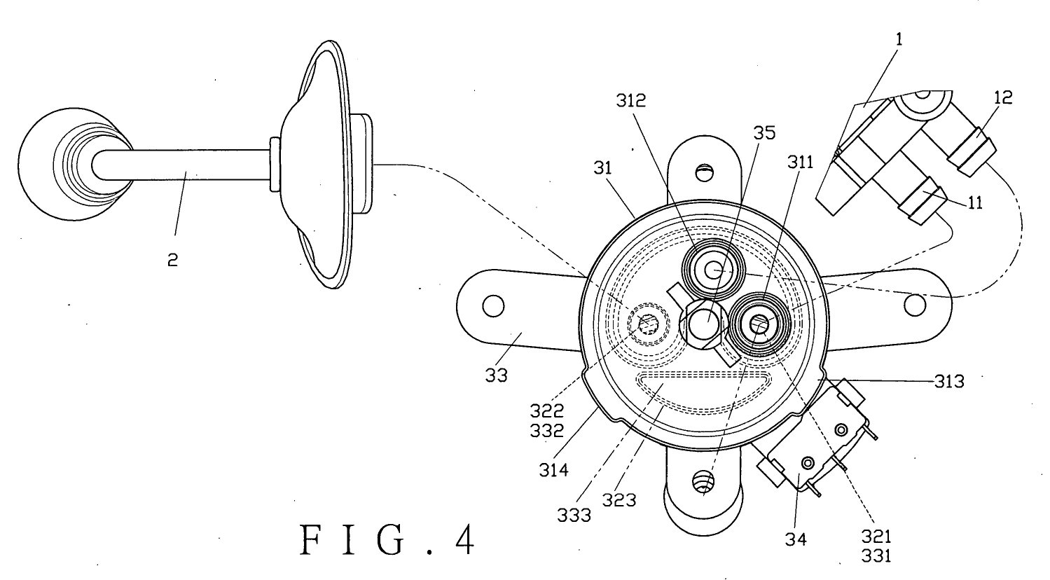

Accordingly, as illustrated in FIG. 4, the lid (31) is turned to have the hot water supply line (311) aligned with the hot water port (321) of the elastic member (32) and the hot water outlet (331) of the base (33). The lug (313) turns on the micro-switch (34) to heat the water in the boiler (1) for the hot water supply line (11) to supply hot water into the coffee pot (4) through the hot water supply line (311), the hot water port (321), the hot water outlet (331) and the hot water supply line (41).

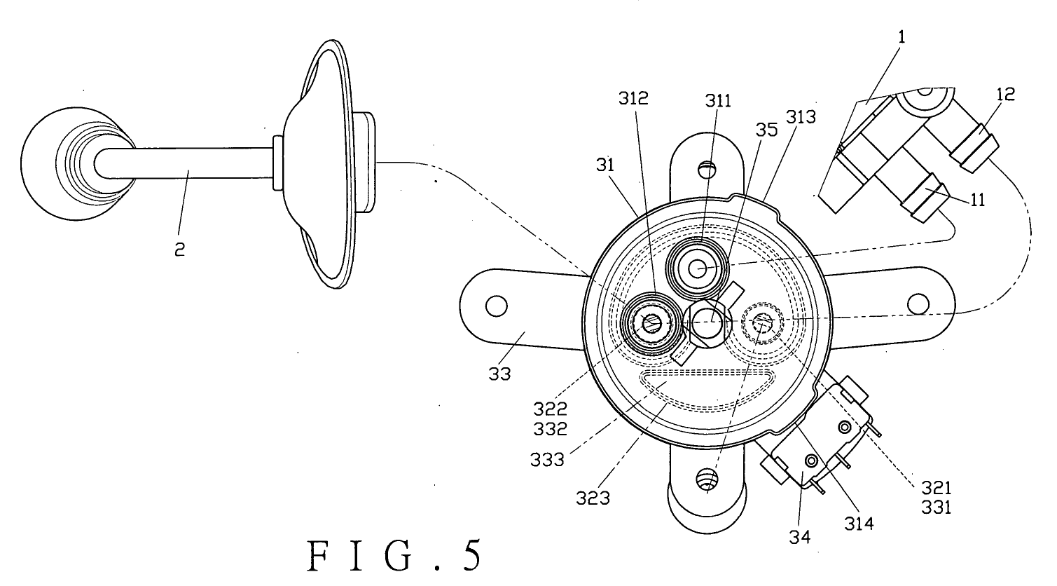

As illustrated in FIG. 5, when the lid (31) is turned to have the steam supply line (312) aligned with the steam port (322) of the elastic member (32) and the steam outlet (332) of the base (33), the lug (134) turns on the micro-switch (34) to heat the water in the boiler (1) to supply steam through the steam supply line (12), another steam supply line (312), the steam port (322), and the steam outlet (332).

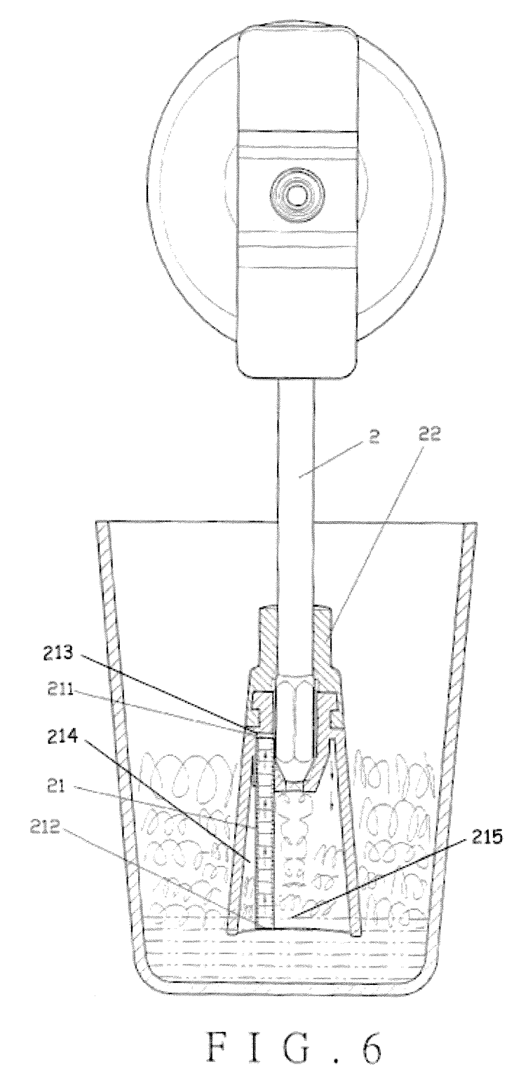

As illustrated in FIG. 6, the steam rushes from the milk whipper (2) into the cap (22) and beats the milk contained in the cap (22) into thick cream while the air in the upper section of the hollow cap (22) is continuously pulled by the steam. Accordingly, negative pressure is formed in the upper section of the cap (22) to suck the milk at the bottom from the second end (212) of the suction tube (21) to flow through the first end (211) into the upper section of the cap (22). The milk is then fully mixed with the steam to allow fast beating for producing thick and consistent cream.

1. A coffee maker comprising a boiler, a milk whipper, a hollow cap coupled to the milk wiper and a selector, the boiler supplying steam to the milk whipper, the milk whipper being received in an open space extending between an upper section and a lower section of the hollow cap to thereby fluidly connect the upper section of the hollow cap within the open space through the milk whipper to the selector, the hollow cap having an open bottom end;
the milk whipper including a suction tube, the suction tube having a first end and a second end, the first end of the suction tube being fixed to an inner side of the cap and being in open communication with the open space at the upper section of the cap, the second end of the suction tube extending through the lower section of the hollow cap to the open bottom end;
the selector including a lid, an elastic member, and a base; the lid being disposed with a hot water supply line and a steam supply line connected to the boiler, the elastic member being fixed to the base, the base being provided with a hot water outlet and a steam outlet, the lid being pivotally connected to the base and holding against the elastic member when in an intermediate position to seal the hot water supply line and the steam supply line of the lid, hot water being supplied when the hot water supply line of the lid is turned to align with the hot water outlet of the base, and steam being supplied when the steam supply line of the lid is turned to align with the steam outlet of the base.

2. The coffee maker of claim 1, wherein the elastic member comprises a hot water port disposed on a surface thereof corresponding to the hot water outlet of the base and a steam port disposed on a surface thereof corresponding to the steam outlet of the base.

3. The coffee maker of claim 1, wherein the elastic member has an indentation disposed on a surface thereof and the base has a corresponding insertion block disposed on a surface thereof to hold the elastic member in position.

4. The coffee maker of claim 1, wherein the base is pivoted to a lower section of a spindle, and the lid is fixed to the spindle and pivoted to the base.

5. A coffee maker comprising a boiler, a milk whipper, a hollow cape and a selector, the boiler supplying steam to the milk whipper through the selector, the milk whipper being received in an open space extending between an upper section and a lower section of the hollow cap to thereby fluidly connect the upper section of the hollow cap within the open space through the milk whipper to the selector, the hollow cap having an open bottom end;
the milk whipper including a suction tube, the suction tube having a first end and a second end, the first end of the suction tube being fixed to an inner side of the cap and being in open communication with the open space at the upper section of the cap, the second end of the suction tube extending through the lower section of the hollow cap to the open bottom.

6. A coffee maker comprising a boiler, a milk whipper, a hollow cape and a selector, the boiler supplying steam to the milk whipper through the selector;
the selector including a lid, an elastic member, and a base; the lid being disposed with a hot water supply line and a steam supply line connected to the boiler, the elastic member being provided with a hot water port and a steam port, the base being provided with a hot water outlet and a steam outlet, the elastic member being fixed to the base, the lid being pivotally connected to the base and holding against the elastic member when in an intermediate position to seal the hot water supply line and the steam supply line of the lid, hot water being supplied when the hot water supply line of the lid is turned to align with the hot water port and the hot water outlet, and steam being supplied when the steam supply line of the lid is turned to align with the steam port and the steam outlet.

7. The coffee maker of claim 6, wherein the hot water port of the elastic member is disposed on a surface thereof and corresponds to the hot water outlet of the base, and the steam port of the elastic member disposed on a surface thereof and corresponding to the steam outlet of the base.

8. The coffee maker of claim 6, wherein a micro-switch is mounted to the base of the selector adjacent the lid; a pair of lugs are disposed on the lid; the micro-switch is electrically connected to the boiler; and the on/off operation of the micro-switch is controlled by turning the lid to align either lug with on actuating arm of the micro-switch.

9. The coffee maker of claim 6, wherein the elastic member has an indentation disposed in a surface thereof and the base has a corresponding insertion block disposed on a surface thereof to hold the elastic member in position.

10. The coffee maker of claim 6, wherein the base is pivoted to a lower section of a spindle, and the lid is fixed to the spindle and pivoted to the base.
